(19) United States
(12) Patent Application Publication
(10) Pub. No.: US 2024/0104628 A1
(43) Pub. Date: Mar. 28, 2024

(54) INFORMATION PROCESSING APPARATUS, INFORMATION PROCESSING METHOD, AND NON-TRANSITORY COMPUTER-READABLE STORAGE MEDIUM

(71) Applicant: NEC CORPORATION, Minato-ku, Tokyo (JP)

(72) Inventor: Atsuko INOUE, Tokyo (JP)

(73) Assignee: NEC CORPORATION, Minato-ku, Tokyo (JP)

(21) Appl. No.: 18/265,887

(22) PCT Filed: Dec. 13, 2021
(86) PCT No.: PCT/JP2021/045761

§ 371 Date: Jun. 7, 2023

(30) Foreign Application Priority Data
Dec. 15, 2020 (JP) 2020-207781

(51) Int. Cl. G06Q 30/0601

(52) U.S. Cl. CPC G06Q 30/0631; G06Q 30/0639; G06Q 30/0641

(57) ABSTRACT

An information processing apparatus (100) includes a display processing unit (102) that transmits information relating to a product to a terminal of a customer being present in a store, and causes the terminal to display the information on a screen, the screen includes a first region, and a second region demarcated from the first region, a product displayed in the first region of the screen is a specific product displayed in a specific location inside the store, and a product displayed in the second region of the screen is either a product being related to a type of the specific product displayed in the first region, or a product specified by the store or a trader.

### TECHNICAL FIELD

The present invention relates to an information processing apparatus, an information processing method, and a program.

### BACKGROUND ART

In a store, various ideas to cause a customer to purchase a recommended product have been devised.

Patent Document 1 describes a product information provision system that can specify in advance, as a memo, a product in which a customer is interested or a product for which a customer desires product information, and displays, on a mobile terminal of the customer, information of the product specified in the memo. The system described in Patent Document 1 can detect, by near-field wireless communication, for example, that a customer is present in a store, and inform of detailed information and a selling location of the product. Patent Document 2 describes a system that displays an advertisement on a mobile terminal of a user, and verifies an effect of the advertisement.

On the other hand, Patent Document 3 describes, in a real store, image-processing a display shelf image capturing a shelf stage (referred to as a golden line) at a position to be on a line of sight of a purchaser of a product, outputting the number of faces of the product as display status information for each position of the shelf stage, and thereby enabling the number of faces of the product displayed on the golden line to be recognized.

Moreover, Patent Document 4 describes performing registration of a product field of interest at membership registration, storing the product field in association with a membership number, acquiring, when the membership number is input at store visit, a product field of interest being associated with the membership number, and displaying, on a mobile terminal of a customer, information of a recommended product in the product field. Further, it is also described that the apparatus causes the mobile terminal of the customer to display a route to a position of a store selling the product.

### RELATED DOCUMENTS

### Patent Documents

Patent Document 1: Japanese Patent Application Publication No. 2007-115220
Patent Document 2: International Publication No. WO2017/085998
Patent Document 3: Japanese Patent Application Publication No. 2018-170044
Patent Document 4: Japanese Patent Application Publication No. 2008-77416

### SUMMARY OF INVENTION

### Technical Problem

In a real store, a display position of a product is a key factor for a customer to recognize the product. On the other hand, it is important to provide information to a customer even for a product that is not displayed at a position being easily recognized by the customer. In this instance, it is also important not to cause the customer to confuse the two types of products.

The present invention has been made in view of the above circumstances, and an object thereof is to cause, when providing a customer with information of a product sold in a real store, the customer to recognize information relating to a product displayed in a specific location, and information relating to another product, in a state of being distinguished from each other.

### Solution to Problem

In each aspect of the present invention, each of the following configurations is adopted in order to solve the problem described above.

A first aspect relates to an information processing apparatus.

The information processing apparatus according to the first aspect includes
a display processing unit that transmits information relating to a product to a terminal of a customer being present in a store, and causes the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

A second aspect relates to an information processing method executed by at least one computer.

The information processing method according to the second aspect includes,
by an information processing apparatus,
transmitting information relating to a product to a terminal of a customer being present in a store, and causing the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

Note that, another aspect of the present invention may be a program causing at least one computer to execute the method according to the second aspect described above, or may be a storage medium being readable by a computer storing such a program. The storage medium includes a non-transitory tangible medium.

The computer program includes a computer program code causing, when executed by a computer, the computer to implement the information processing method on an information processing apparatus.

Note that, any combination of the above components and a conversion of an expression of the present invention among a method, an apparatus, a system, a storage medium, a computer program, and the like are also effective as an aspect of the present invention.

Moreover, various components according to the present invention do not necessarily need to be independent of each other, and may be in such a way that a plurality of components are formed as one member, one component is formed of a plurality of members, a certain component is a part of another component, a part of a certain component overlaps a part of another component, or the like.

Moreover, although the method and the computer program according to the present invention describe a plurality of procedures in order, the order of description does not limit an order in which the plurality of procedures are executed. Thus, when implementing the method and the computer program according to the present invention, the order of the plurality of procedures can be changed within a scope that does not cause inconvenience in terms of content.

Furthermore, the method and the plurality of procedures of the computer program according to the present invention are not limited to being executed at timings different from each other. Thus, there may be such a case that, during execution of a certain procedure, another procedure occurs, may be such a case that an execution timing of a certain procedure and an execution timing of another procedure partly or entirely overlap each other, or the like.

### Advantageous Effects of Invention

Each of the above aspects can cause, when providing a customer with information of a product sold in a real store, the customer to recognize information relating to a product displayed in a specific location, and information relating to another product, in a state of being distinguished from each other.

### BRIEF DESCRIPTION OF THE DRAWINGS

FIG. 1 It is a diagram schematically illustrating a system configuration of a sales promotion system according to an example embodiment of the present invention.

FIG. 2 It is a block diagram illustrating a hardware configuration of a computer achieving an information processing apparatus.

FIG. 3 It is a functional block diagram logically illustrating a configuration of an information processing apparatus according to the example embodiment.

FIG. 4 It is a diagram for describing a prime place of a display shelf.

FIG. 5 It is a diagram illustrating a layout example of a store.

FIG. 6 It is a diagram illustrating one example of a screen displayed on a user terminal.

FIG. 7 It is a diagram illustrating a data structure example of each piece of information stored in a storage apparatus of the information processing apparatus.

FIG. 8 It is a diagram for describing a content to be displayed at each of positions inside a prime place region and a secondary place region of a screen.

FIG. 9 It is a flowchart illustrating one example of an operation of the information processing apparatus according to the example embodiment.

FIG. 10 It is a flowchart illustrating a detailed procedure of display processing of the screen in step S105 in FIG. 9.

FIG. 11 It is a flowchart illustrating an operation example when a content display portion in the prime place region is pressed after the screen is displayed in FIG. 10.

FIG. 12 It is a functional block diagram illustrating a logical configuration example of an information processing apparatus according to another example embodiment.

FIG. 13 It is a functional block diagram illustrating a logical configuration example of an information processing apparatus according to another example embodiment.

FIG. 14 It is a diagram for describing transition of a screen.

FIG. 15 It is a flowchart illustrating an operation example when a content display portion of a secondary place region of a screen is pressed.

### EXAMPLE EMBODIMENT

Hereinafter, example embodiments of the present invention are described by use of the drawings. Note that, in all of the drawings, a similar component is assigned with a similar reference sign, and description thereof is omitted as appropriate. Moreover, in each of the following figures, a configuration of a portion that does not concern essence of the present invention is omitted, and is not illustrated.

In the example embodiment, “acquisition” includes at least one of fetching, by a local apparatus, data or information stored in another apparatus or a storage medium (active acquisition), and inputting, into a local apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

### First Example Embodiment

### <System Outline>

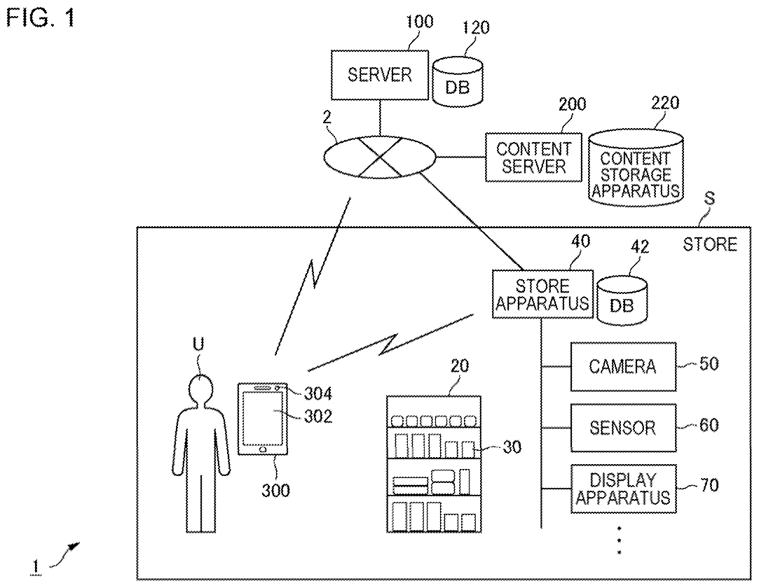

FIG. 1 is a diagram schematically illustrating a system configuration of a sales promotion system 1 according to an example embodiment of the present invention. The sales promotion system 1 includes a server 100, a content server 200, a user terminal 300, and a store apparatus 40. The server 100, the content server 200, the user terminal 300, and the store apparatus 40 are connected to one another via a communication network 2.

The server 100 is equivalent to an information processing apparatus 100 according to the present example embodiment described later. The information processing apparatus 100 provides product information to the user terminal 300 of a user U being a customer of a store S. The server 100 includes a storage apparatus 120 (in the figure, indicated as a “database (DB)”. However, the storage apparatus is not limited to database structure.). The storage apparatus 120 may be an apparatus separate from the server 100, may be an apparatus included inside the server 100, or may be a combination thereof.

The content server 200 manages a content such as product information provided to the user terminal 300 of the user U being a customer. The content server 200 includes a content storage apparatus 220 storing a content. The content storage apparatus 220 may be an apparatus separate from the content server 200, may be an apparatus included inside the content server 200, or may be a combination thereof.

The user terminal 300 is a terminal that the user U carries inside the store S and uses while looking at a screen. The user terminal 300 may be belongings of the user U, or may be a rented terminal (e.g., a terminal installed in a cart used inside the store S, or the like).

The user U performs user registration in advance in order to utilize a service provided by the sales promotion system 1. Account information of the user U (e.g., a user name (user ID) and a password, or the like) is registered in the information processing apparatus 100. Alternatively, it may be linked with account information of an existing social networking service (SNS). The user U can utilize the sales promotion system 1 in the user terminal 300 by installing a dedicated application in the user terminal 300. By logging in to the sales promotion system 1 by use of the user-registered account information, a service provided by the sales promotion system 1 becomes utilizable.

In other words, the information processing apparatus 100 is achieved by cooperation of the server 100, the content server 200, and the application installed in the user terminal 300.

Moreover, instead of an application, a predetermined website may be accessed with a browser, and the sales promotion system 1 may be logged in to by use of account information.

Moreover, when login is successful after an application dedicated to the sales promotion system 1 is installed, it is preferable that account information of the user U is stored in the application. Then, automatic login may be able to be performed by use of stored account information from next application activation. Moreover, as described later, a service of the present sales promotion system 1 may be configured to be able to be utilized by automatically logging in only when it can be determined that the user U is present inside the store S after application activation. A sensing method of presence of the user U inside the store S is described later.

The store apparatus 40 manages a product in the store S. The store apparatus 40 includes a storage apparatus 42 (in the figure, indicated as a “database (DB)”. However, the storage apparatus is not limited to database structure) storing information of a product managed in the store. However, the storage apparatus 42 may be an apparatus separate from the store apparatus 40, may be an apparatus included inside the store apparatus 40, or may be a combination thereof.

The store apparatus 40 manages information of a product 30 displayed on a display shelf 20 inside the store S. A camera 50 is installed inside the store S. The camera 50 may be installed on a ceiling or the like of the store S and capture the entire store S, or may be installed on the display shelf 20 or the like in a specific location and capture the specific location. The store apparatus 40 acquires an image captured by the camera 50. Further, various sensors 60 such as a weight sensor may be installed on the display shelf 20. The store apparatus 40 acquires a detection result from the sensor 60.

In the figure, the camera 50, the sensor 60, and a display apparatus 70 are illustrated in such a way as to be connected to the communication network 2 via the store apparatus 40, but the present invention is not limited thereto. The camera 50, the sensor 60, and the display apparatus 70 may be directly connected to the communication network 2 without intervention of the store apparatus 40.

Further, various display apparatuses 70 may be installed on the display shelf 20 and inside the store S. The store apparatus 40 also performs display processing on the display apparatus 70. Specifically, the display apparatus 70 is a display for a price tag displaying a price of the product 30 displayed on the display shelf 20, a signage, provided inside the store S, that displays a content such as a product introduction, an in-store guide, and an advertisement, or the like.

### <Hardware Configuration Example>

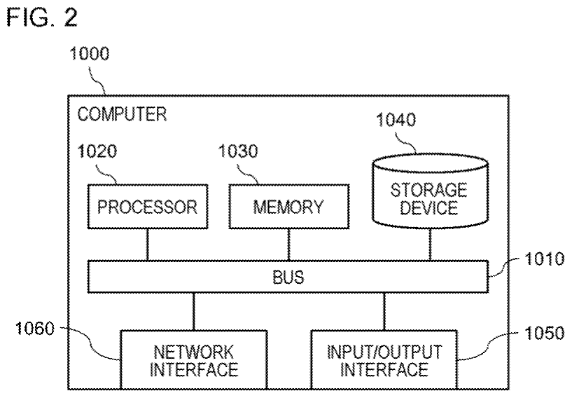

FIG. 2 is a block diagram illustrating a hardware configuration of a computer 1000 achieving the information processing apparatus (server) 100 described later. The content server 200, the user terminal 300, the store apparatus 40, and the like in FIG. 1 are also achieved by the computer 1000. Moreover, at least two of the server 100, the content server 200, and the store apparatus 40 may be achieved by one computer, or each apparatus may be achieved by at least two computers. That is to say, the server 100, the content server 200, and the store apparatus 40 may be included in the same apparatus, or may be separate apparatuses.

The server 100, the content server 200, and the store apparatus 40 are achieved by, for example, a personal computer, a server computer, or the like. The user terminal 300 is, for example, a smartphone, a tablet terminal, a mobile phone, a personal digital assistant (PDA), a personal computer, or the like, and includes a touch panel 302 having functions of a display unit and an operation unit, an operation acceptance unit such as a switch, a sound input/output unit (a speaker and a microphone), a vibration unit, and a camera 304.

The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (e.g., a display processing unit 102, a product determination unit 104, a decision unit 106, a customer identification unit, an image processing unit, and the like described later) of the information processing apparatus (server) 100. The processor 1020 reads each of the program modules onto the memory 1030, executes the read program module, and thereby achieves each function being associated with the program module. Moreover, the storage device 1040 may also store each piece of data in the storage apparatus 120 of the server 100, the content storage apparatus 220 of the content server 200, and the storage apparatus 42 of the store apparatus 40.

The program module may be stored in a storage medium. A storage medium storing the program module may include a non-transitory tangible medium usable by the computer 1000, and a program code readable by the computer 1000 (the processor 1020) may be embedded in the medium.

The input/output interface 1050 is an interface for connecting the computer 1000 to various kinds of input/output equipment. The input/output interface 1050 also functions as a communication interface that performs near-field wireless communication such as Bluetooth (registered trademark) and near field communication (NFC).

The network interface 1060 is an interface for connecting the computer 1000 to the communication network 2 (FIG. 1). The communication network 2 is, for example, a local area network (LAN) or a wide area network (WAN). A method of connecting the network interface 1060 to the communication network 2 may be wireless connection, or may be wired connection.

Then, the computer 1000 is connected to necessary equipment (e.g., the store apparatus 40, the camera 50, the sensor 60, the display apparatus 70, or the like) via the input/output interface 1050 or the network interface 1060.

The camera 50 or the camera 304 of the user terminal 300 includes a lens and an image capturing element such as a charge coupled device (CCD) image sensor. The camera 50 is a network camera such as, for example, an Internet protocol (IP) camera. The network camera includes, for example, a wireless local area network (LAN) communication function, and is connected to the store apparatus 40 or the server 100 via a relay apparatus (not illustrated) such as a router of the communication network 2. Then, the camera 50 may include a mechanism that follows a movement of a person inside the store S, and performs control of orientation of a camera body and a lens, zoom control, focusing, and the like.

An image generated by the camera 50 is preferably captured in real time, and transmitted to the store apparatus 40 or the server 100. However, an image transmitted to the store apparatus 40 or the server 100 may not be directly transmitted from a camera 5, and may be an image delayed by a predetermined time. An image captured by the camera 50 may be temporarily stored in another storage apparatus, and read from the storage apparatus by the store apparatus 40 or the server 100 sequentially or at a predetermined interval. Further, an image transmitted to the store apparatus 40 or the server 100 is preferably a moving image, but may be a frame image at a predetermined interval, or may be a still image.

The display apparatus 70 is, for example, a liquid crystal display, an organic electro-luminescence (EL) display, or the like.

### <Function Configuration Example>

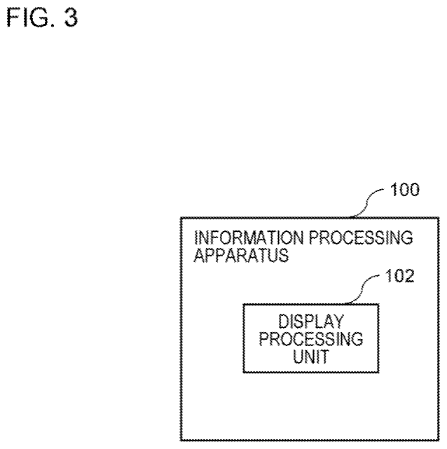

FIG. 3 is a functional block diagram logically illustrating a configuration of the information processing apparatus 100 according to the example embodiment of the present invention.

The information processing apparatus 100 includes a display processing unit 102 that transmits information relating to a product to the user terminal 300 of a customer (user U) being present in the store S, and displays the information on a screen 400.

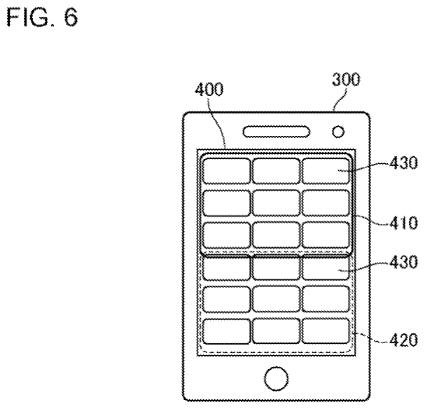

As illustrated in FIG. 6, the screen 400 includes a first region 410 (hereinafter, also referred to as a “prime place region 410”) and a second region 420 (hereinafter, also referred to as a “secondary place region 420”) demarcated from the prime place region 410.

A product displayed in the first region 410 of the screen 400 is a specific product displayed in a specific location (hereinafter, also referred to as a “golden line”) inside the store S. A product displayed in the second region 420 of the screen 400 is a product being related to a type of a specific product 32 displayed in the first region 410, or being specified by the store S or a trader (a manufacturer, a dealer, or the like).

That is to say, a specific product may be, for example, a product targeted for sales promotion by the store S, a manufacturer, a dealer, or the like. Alternatively, a specific product may be a popular product, a featured product, a seasonal and event product, a product being high in sales, a product desired to be increased in sales, a product being high in profit margin, a rebate-targeted product, a close-out product, a bargain product, or the like.

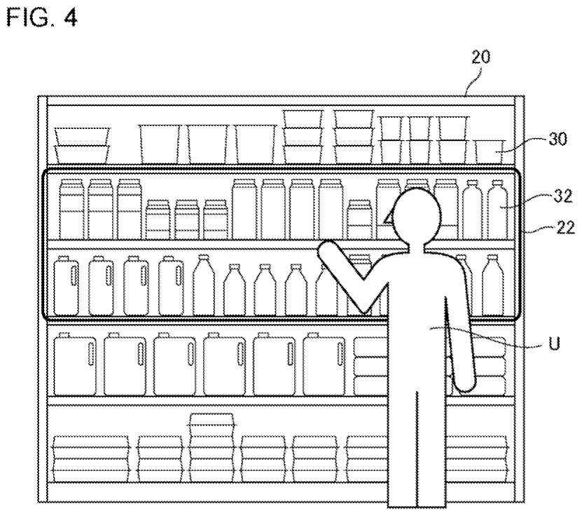

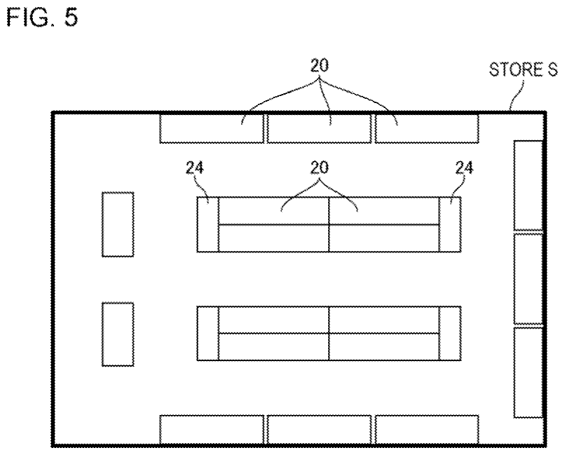

As illustrated in FIG. 4, in the store S, a specific product targeted for sales promotion is displayed at a position of a height on a line of sight of the customer user U, being, for example, a so-called golden line of the display shelf 20. That is to say, in the present example embodiment, a specific location is a shelf at a predetermined height of the display shelf 20. Alternatively, as illustrated in FIG. 5, a specific location may be an end display portion 24 of a corner lot (so-called “end”) in a region where a plurality of the display shelves 20 are arranged. In the present example embodiment, the location is also referred to as a prime place 22.

FIG. 6 is a diagram illustrating one example of the screen 400 displayed on the user terminal 300. The screen 400 includes the prime place region 410 and the secondary place region 420. The prime place region 410 and the secondary place region 420 include a content display portion 430 in which a content indicating product information of the at least one product 30 is displayed. The prime place region 410 includes a region on at least an upper side and/or a left side of the screen 400. In FIG. 6, the prime place region 410 is a region of an upper half of the screen 400 acquired by dividing the screen 400 into upper and lower two parts, and the secondary place region 420 is a region of a lower half of the screen 400, but the present invention is not limited thereto. An occupied area ratio between the prime place region 410 and the secondary place region 420 is not limited to 1:1. A proportion of the prime place region 410 may be increased, or a proportion of the secondary place region 420 may be increased.

Moreover, a size and a shape of each of all the content display portions 430 are the same in the figure, but a size of the content display portion 430 may be different from each other. Moreover, the content display portion 430 included in the prime place region 410 may be larger in area than the content display portion 430 included in the secondary place region 420, and vice versa. The shapes of the content display portions 430 may also be different from each other.

The prime place region 410 is a region being easy for the user U to see, a region having a high probability of being noticed first, a region considered to have a high advertising effect, or the like, among all regions of the screen 400. The secondary place region 420 includes at least a part of a region other than the prime place region 410, among regions of the screen 400.

In other words, the prime place region 410 in FIG. 6 can be said to be a virtual version of the prime place 22 (golden line) of the actual display shelf 20 in FIG. 4. The content display portion 430 that displays a content including information of the specific product 32 is disposed in the prime place region 410. That is to say, it can also be said that the specific product 32 is equivalent to a product specified by the store S or a trader (a manufacturer, a dealer, or the like) in such a way as to be displayed in the prime place 22 of the display shelf 20 as a sales promotion target.

As another example, the content display portion 430 that displays a content including information of a product including a product specified in advance such as a product that the user U being a customer is, for example, considering to purchase, a product selected based on a browsing history of the user U in an advertising content, a product searched for by the user U, or the like may be displayed in the prime place region 410.

For example, the display processing unit 102 may cause the user terminal 300 to display a menu screen that causes the user U to select a menu for dinner, and, when curry is selected, cause the prime place region 410 to display information of the specific product 32 displayed in the prime place 22 of the display shelf 20 of the store S in which a roux of curry is displayed.

The content display portion 430 may include at least one of an image and a text. An image of a product, a product name, a selling price, discount information, a catch phrase, and the like may be included. A format of an image is a still image, a moving image, an animation, or the like, and is not particularly limited. The content display portion 430 may accept pressing by the user U, and further shift to a screen (not illustrated) that displays detailed information of the product. The detailed information may be, for example, information of a location where a product is sold, may be navigation that guides the user U to the location, or may be a product advertisement content.

A content displayed in the prime place region 410 and a content displayed in the secondary place region 420 may be products being related to each other. For example, when a content including information of a roux of curry is displayed on the content display portion 430 in the prime place region 410, the content display portion 430 in the secondary place region 420 may display a content including information relating to an ingredient, such as meat, an onion, a potato, and a carrot, serving as an ingredient of the curry. Further, the content display portion 430 in the secondary place region 420 may display, in relation to curry, a content including information relating to an accompaniment or a topping material such as Fukujinzuke, a shallot, cheese, and a raisin, or information of an ingredient relating to a menu similar to curry (e.g., hashed beef, cream stew, or the like) or an arranged menu (e.g., curry doria, curry udon, curry pilaf, or the like).

In another example, when the content display portion 430 in the prime place region 410 displays a content including information of an alcoholic beverage, the content display portion 430 in the secondary place region 420 may display a content including information relating to an appetizer. When the content display portion 430 selected in the prime place region 410 is wine, the content display portion 430 in the secondary place region 420 may display a content including information being related to cheese, nuts, uncured ham, or the like suitable for an appetizer of wine.

From among a plurality of types of roux of curry displayed on a plurality of the content display portions 430 in the prime place region 410, a product to be displayed in the secondary place region 420 may be changed according to a type of a roux of curry displayed on the selected content display portion 430. For example, according to a type of a roux such as ordinary curry, keema curry, hashed beef rice, beef stew, and cream stew, the content display portion 430 including product information of an ingredient commonly used in an associated dish may be displayed in the secondary place region 420. As described above, in a case of a roux of ordinary curry, the content display portion 430 including information relating to an ingredient such as meat, an onion, a potato, and a carrot is displayed in the secondary place region 420, but, in a case of a roux of keema curry, the content display portion 430 including information relating to an ingredient such as minced meat, an onion, a carrot, an eggplant, and a paprika is displayed in the secondary place region 420.

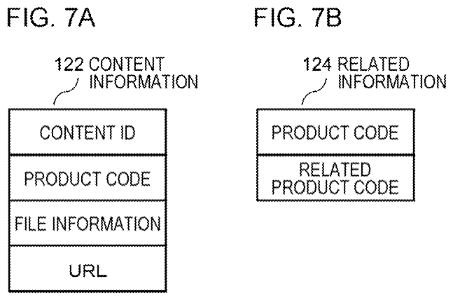

FIG. 7 is a diagram illustrating a data structure example of each piece of information stored in the storage apparatus 120. Registration of data in the storage apparatus 120 may be configured in such a way that an administrator of the store S or a trader inputs from an operation terminal (not illustrated) by use of an operation screen, and the server 100 accepts. For example, an operation screen for registration may be able to be displayed on the operation terminal by accessing a website dedicated to a predetermined administrator. Alternatively, the server 100 may display an operation screen dedicated to an administrator that accepts registration. The operation screen may directly accept, for example, an input of a product code, or may accept an input of a product image, a product name, and a keyword, search for a product from the pieces of information, and acquire and register a product code.

For example, content information 122 in FIG. 7(a) associates information such as a product code determining a product with a content ID being identification information of a content including information of the product. Information relating to a content of the product to be displayed on the content display portion 430 is registered in the content information 122.

A content is at least one of an image file and a text file to be displayed on the content display portion 430 as described above. The content information 122 may be further associated with file information such as a storage location and a file name of a data file, and information of a uniform resource locator (URL) of a website of predetermined product information displayed by pressing the content display portion 430.

Related information 124 in FIG. 7(b) is associated with at least one product being related to a certain product. As described above, the product of a curry roux may be associated with a product code of a related product.

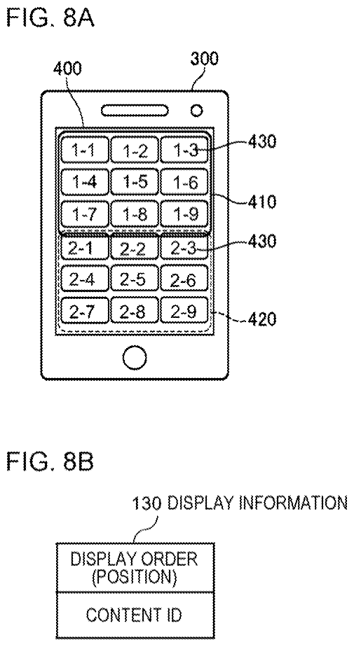

FIG. 8 is a diagram for describing a content displayed at each position inside the prime place region 410 and the secondary place region 420 of the screen 400.

As illustrated in FIG. 8(a), disposition of the content display portion 430 in each region of the screen 400, and a display order of each position (e.g., “1-1” or the like) are specified in advance. Further, a size, a shape, and the like of each region may be able to be specified. These may be able to be specified by use of an operation screen for an administrator.

Display information 130 in FIG. 8(b) stored in the storage apparatus 120 associates a display order (e.g., a position such as “1-1”) indicating a position of the content display portion 430 in the prime place region 410 of the screen 400 in FIG. 8(a), with a content ID displayed at the display position. In the present example embodiment, a product displayed at each position of the prime place region 410 is the specific product 32 displayed at the specific location of the store S. As described above, the specific product 32 is a product that the store S or a trader desires to perform sales promotion, and may be specified by the store S or the trader. These may be able to be specified by use of an operation screen for an administrator.

### <Operation Example>

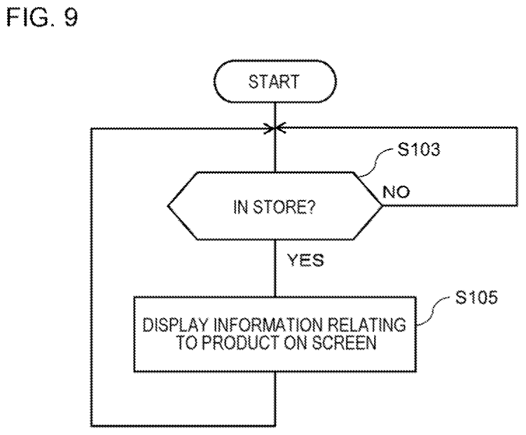

FIG. 9 is a flowchart illustrating one example of an operation of the information processing apparatus 100 according to the present example embodiment.

First, when presence of the user U in the store S is sensed (YES in step S103), the present processing is started. When presence of the user U in the store S is sensed (YES in step S103), the display processing unit 102 transmits information relating to a product to the user terminal 300, and causes the touch panel 302 to display the screen 400 (step S105).

In step S101, sensing methods for presence of the user U in the store S include (a) a case where the user terminal 300 (application) senses, (b) a case where the server 100 senses, and (c) a case where the user U specifies by use of the user terminal 300 (application). Exemplifications are presented below, but the present invention is not limited thereto.

Moreover, the following plurality may be combined.
<a: A Case where the User Terminal 300 (Application) Senses>
(a1) A case where the application periodically acquires current position information acquired by a global positioning system (GPS) reception unit of the user terminal 300, decides whether the current position information indicates position information of the store S or a position within a range around the store S, and senses that the current position information indicates the position information of the store S or the position within the range around the store S
(a2) A case where the application monitors whether wireless communication between a repeater (a router, a GW, or the like) provided in the store S and the user terminal 300 has been established, and senses establishment of the wireless communication
(a3) A case where the application monitors whether the user terminal 300 has received a beacon transmitted from communication with, for example, a Bluetooth (registered trademark) communication apparatus provided in the store S, and senses that the user terminal 300 has received the beacon (a4) A case where the application senses that a microphone of the user terminal 300 has received an ultrasonic wave of a predetermined frequency output from an ultrasonic wave generation apparatus provided in the store S

### <b: A Case Where the Server 100 Senses>

(b1) A case where the server 100 periodically acquires, from the user terminal 300 (via an application), current position information (hereinafter, referred to as “GPS position information”) acquired by a global positioning system (GPS) reception unit of the user terminal 300, decides whether the current position information indicates position information of the store S or a position within a range around the store S, and senses that the current position information indicates the position information of the store S or the position within the range around the store S
(b2) A case where the server 100 monitors whether wireless communication between a repeater (a router, a GW, or the like) provided in the store S and the user terminal 300 (when an application is activated, the user U can be identified by using a user ID of the user U for wireless connection) has been established, and senses establishment of the wireless communication with the user terminal 300
(b3) A case where the server 100 monitors whether the user terminal 300 has responded to a beacon transmitted from, for example, a Bluetooth communication apparatus or the like provided in the store S, and senses a response of the user terminal 300
(b4) Store entry of the user U may be sensed by use of a store entry terminal in the store S. User information may be read from an IC chip of the user terminal 300 of the user U or a membership card (a magnetic card or an IC card) of the store S. The user information may be read from the IC chip by, for example, near field communication (NFC) communication, or may be read by a magnetic card reader.

### <c: A Case Where the User U Specifies>

(c1) A two-dimensional code such as a quick response (QR) code (registered trademark) posted at a predetermined location of the store S is read by use of the user terminal 300, and an application determines the store S indicated by the read information, or senses presence in the store S.
(c2) An application transmits the information read in (c1) described above to the server 100, and determines, from the information received by the server 100, the store S in which the user terminal 300 is present.

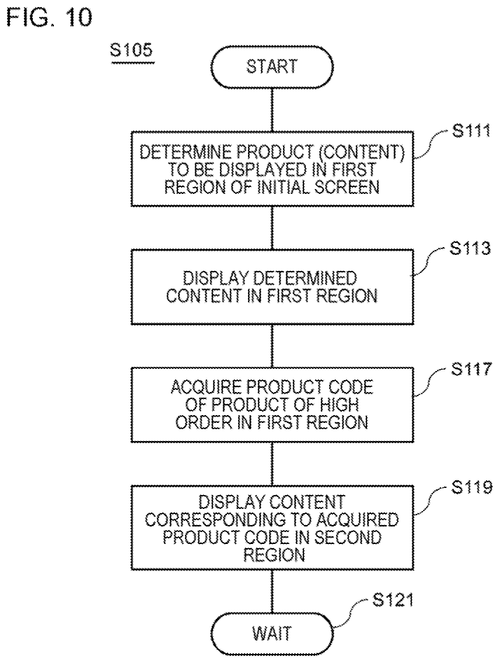

FIG. 10 is a flowchart illustrating a detailed procedure of display processing of the screen 400 in step S105 in FIG. 9. First, the display processing unit 102 determines a content to be displayed in the prime place region 410 of the initial screen 400 (step S111). For example, the display processing unit 102 refers to the display information 130 in FIG. 8(b), and determines a content (content ID) to be displayed on the content display portion 430 at each position of the prime place region 410.

Then, the display processing unit 102 refers to the content information 122 in FIG. 7(a), acquires an image or a text file, and a URL being associated to the content ID to be displayed on the content display portion 430 at each position, and displays the image or the text on the content display portion 430 at each position in the prime place region 410 in a state where a link is embedded (step S113).

Next, regarding the secondary place region 420, the display processing unit 102 refers to the related information 124 in FIG. 7(b), and, in the initial screen 400 before an operation of the user U, acquires a related product code being associated to a product code of a content displayed at the position in order of a display order (high order) of the prime place region 410 (step S117).

Then, the display processing unit 102 refers to the content information 122, acquires the information (content ID) of a content being associated to the acquired related product code, and acquires an image or a text file to be displayed on the content display portion 430. Then, the display processing unit 102 acquires an image or text, and a URL in order of a display order (e.g., in order of 2-1, 2-2, 2-3, . . . in FIG. 8(a)) in the content display portion 430 in the secondary place region 420, and displays the image or the text on the content display portion 430 at each position in the secondary place region 420 in a state where a link is embedded (step S119). Thereafter, the display processing unit 102 enters a state of waiting for acceptance of an operation of the user U (step S121).

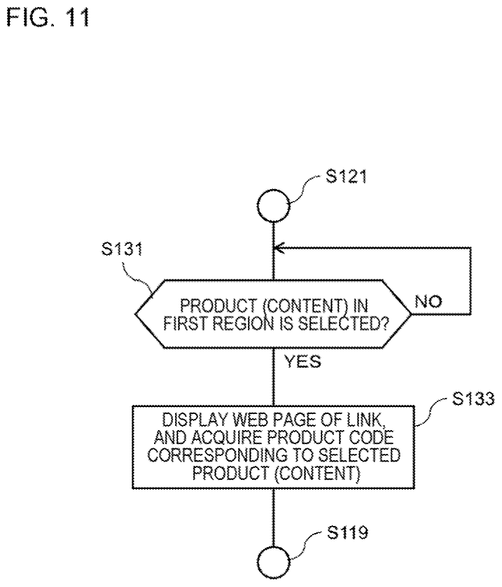

FIG. 11 is a flowchart illustrating an operation example when the content display portion 430 in the prime place region 410 is pressed after the screen 400 is displayed in FIG. 10 (step S121).

When the user U presses one of the content display portions 430 in the prime place region 410 (YES in step S131), the display processing unit 102 accesses a URL indicated by a link embedded in the content display portion 430, and displays a web page (step S133). Thereby, the user U can browse detailed information of a selected product. When a screen (not illustrated) displaying the detailed information of the product is closed, a return is made to the screen 400. Alternatively, display may be switched to the screen 400 without closing the detailed screen of the product.

In the screen 400, the content display portion 430 in the secondary place region 420 may be changed to information relating to the related product being associated to the content display portion 430 selected by the user U. Hereinafter, changing processing of the content display portion 430 in the secondary place region 420 according to a selection operation of the user U is performed.

The display processing unit 102 acquires, with reference to the content information 122 in FIG. 7(a), a product code being associated to the content ID (FIG. 8(b)) displayed on the content display portion 430 pressed in step S131 (step S133).

Then, proceeding to step S119 in FIG. 10, the display processing unit 102 refers to the content information 122, acquires information (content ID) of a content being associated to a product code of the selected content display portion 430, and acquires an image or a text file, and a URL to be displayed on the content display portion 430. Then, the display processing unit 102 displays, on the content display portion 430 in the secondary place region 420, the image or the text in a state where a link is embedded at a position (e.g., a position of 2-1 in FIG. 8(a)) being high in order of a display order. Note that, a case where the content display portion 430 in the secondary place region 420 is selected is described in a fifth example embodiment described later.

In the present example embodiment, the display processing unit 102 transmits information relating to a product to the user terminal 300 of the customer user U being present in the store S, and displays the information on a screen, and the screen 400 includes the prime place region 410, and the secondary place region 420 demarcated from the prime place region 410.

According to the present example embodiment, a product displayed in the prime place region 410 of the screen 400 is the specific product 32 displayed in a specific location inside the store S, and, therefore, when information of a product sold in a real store is provided to a customer, the customer can be caused to recognize information relating to a product displayed in a specific location, and information relating to another product, in a state of being distinguished from each other.

Further, according to the present example embodiment, a product displayed in the secondary place region 420 of the screen 400 is a product being related to a type of the specific product 32 displayed in the prime place region 410, or being specified by the store S or a trader, and, therefore, information relating to a product that the store S or the trader desires to sell can be efficiently presented to a customer.

### Second Example Embodiment

The present example embodiment is the same as the example embodiment described above except that a display processing unit 102 includes a configuration in which products displayed on a prime place region 410 and a secondary place region 420 of a screen 400 do not overlap each other, and is therefore described by use of FIG. 3 according to the example embodiment described above. Note that, a configuration according to the present example embodiment may be combined with at least one of configurations according to other example embodiments within a scope that does not cause a contradiction.

When a product that should be displayed in the secondary place region 420 of the screen 400 overlaps a product that should be displayed in the prime place region 410 of the screen 400, the display processing unit 102 does not display the overlapping product in the secondary place region 420.

In a processing procedure in FIG. 10 of the display processing unit 102 described in the above example embodiment, in step S119, the display processing unit 102 refers to a content information 122, refers to display information 130 in FIG. 8(b) when acquiring information (content ID) of a content being associated to the acquired related product code, and decides whether a content ID at each display position of the prime place region 410 matches a content ID being associated to the related product code. When the content IDs match, the products overlap, therefore, the content ID is not used, related information 124 in FIG. 7(b) is referred to, another related product code is acquired, and processing is continued. However, instead of a content ID, it may be decided whether a product code (related product code) of a product that should be displayed in the secondary place region 420 matches a product code of a product displayed in the prime place region 410.

Note that, when another related product code is not associated with the related information 124, at least one product code (content ID) that should be displayed is specified in advance by an administrator or a trader, and, thereby, the content display portion 430 can be displayed in the secondary place region 420 even when there is not the another related product code. Alternatively, when there is not another related product code, a content may be randomly selected and displayed.

Moreover, the display processing unit 102 may further highlight an overlapping product in the prime place region 410 of the screen 400.

When a product code (or a content ID being associated to a product code) of a product that should be displayed in the secondary place region 420 matches a product code (or a content ID being associated to a product code) of a product displayed in the prime place region 410 in step S119 described above, the display processing unit 102 highlights the content display portion 430 displayed in the prime place region 410, regarding the matched product.

Various highlighting methods can be considered, such as blinking display, animation display, three-dimensional display, and enlarged display, and the present invention is not limited thereto. A display method may be any method that enhances visibility to a user U by providing emphasis as compared to another content display portion 430.

According to the present example embodiment, since an advantageous effect similar to that according to the first example embodiment is provided, and, when products to be displayed in the secondary place region 420 and the prime place region 410 overlap each other, the product is not displayed in the secondary place region 420, another product can be displayed in the space, and display efficiency of the screen 400 can be improved. Moreover, since information of an overlapping product can be highlighted, visibility of information of the product selected in both the prime place region 410 and the secondary place region 420 under predetermined condition can be improved, and a product can be efficiently recommended to a customer more effectively.

### Third Example Embodiment

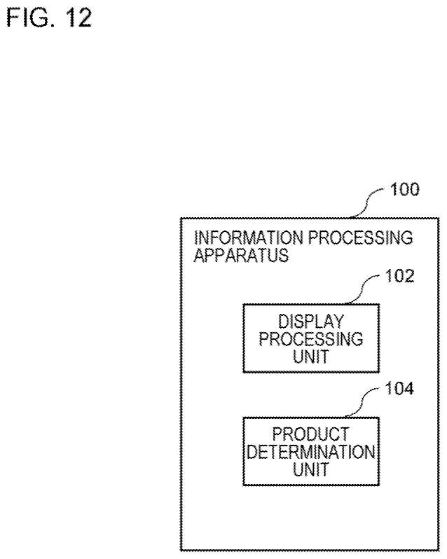

FIG. 12 is a functional block diagram illustrating a logical configuration example of an information processing apparatus 100 according to the present example embodiment. The present example embodiment is similar to one of the first and second example embodiments described above except that the present example embodiment includes a configuration that determines a specific product 32 by capturing an image of a shelf in a store S and processing the image. Note that, a configuration according to the present example embodiment may be combined with at least one of configurations according to other example embodiments described later within a scope that does not cause a contradiction.

The information processing apparatus 100 further includes a product determination unit 104 that determines the specific product 32 displayed at a specific location, by processing an image capturing a display shelf 20 inside the store S. Then, a display processing unit 102 displays the determined specific product 32 in a prime place region 410 of a screen 400.

Capturing of the display shelf 20 can be performed by at least one of a camera 50 installed inside the store S and a camera 304 of a user terminal 300 of a user U.

When the camera 50 in the store S is used, a specific location inside the store S (e.g., a shelf of a predetermined height (a prime place 22 in FIG. 4) or an end display portion 24 in FIG. 5) is periodically captured by the camera 50, and a product displayed at the location is determined by image processing. An image processing unit (not illustrated) may be inside the information processing apparatus 100, or may be an apparatus separate from the information processing apparatus 100.

With a specific location inside the store S as a capturing location, capturing information such as a capturing direction and an angle of view may be specified in advance. The camera 50 can capture the specific location by referring to the capturing information. Alternatively, an image of the specific location captured by an operator of the store S by operating the camera 50 may be used. A timing of capturing may be periodic, or may be a specific timing, for example, a timing after product replacement work or the like.

A case of capturing by use of the camera 304 of the user terminal 300 of the user U is described. Capturing by the camera 304 may be started after presence of the user U in the store S is sensed (YES in step S103 in FIG. 9), or a guidance may be displayed on a touch panel 302 of the user terminal 300, and the user U may be instructed to go in front of the display shelf 20 and capture the display shelf 20 with the user terminal 300. According to the guidance, the user U may stand in front of the display shelf 20, and capture the display shelf 20 with the camera 304. The user terminal 300 may include an image processing unit, or may transmit a captured image to the information processing apparatus 100 and cause image processing to be performed on an information processing apparatus 100 side.

Various methods of identifying a specific location of 20 from a captured image can be conceived, and are exemplified below, but the present invention is not limited thereto. Moreover, a plurality of the following may be combined.
(1) A ratio of a height of the display shelf 20 to a height of a position of the shelf in the prime place 22 is registered in advance. The display shelf 20 within an image is determined by image recognition processing, and a position of a shelf in the prime place 22 of the display shelf 20 within the image is determined by use of the ratio. A position of the shelf in the prime place 22 may have a width in a height direction. A proportion of a width to a height of the display shelf 20 may also be registered.
(2) A shelf at a specific location of the display shelf 20 is provided with a two-dimensional code such as a QR code storing information indicating a position of the shelf, the QR code within a captured image is read, and the position of the shelf is determined. The QR code may be displayed on a display for a price tag, or the like provided on a front surface of a shelf board.

Then, after the prime place 22 is determined, a product displayed at a location of the prime place 22 is determined by image processing. For example, a feature value or an image of a product handled in the store S can be registered in a storage apparatus 120 in advance in association with a product code, and the product code can be determined by image processing.

According to the present example embodiment, since an advantageous effect similar to that according to the first example embodiment is provided, and, further, a product to be displayed in the prime place region 410 can be determined based on status of the display shelf 20 in the real store S, a product to be displayed can be selected by reflecting status of a sales area in real time. Thus, sales promotion can be effectively performed without missing an opportunity for sales promotion.

### Fourth Example Embodiment

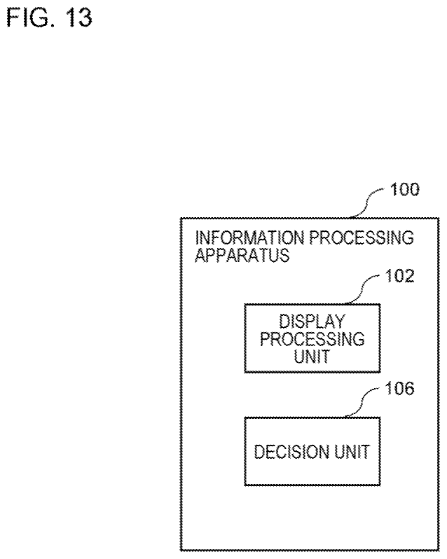

FIG. 13 is a functional block diagram illustrating a logical configuration example of an information processing apparatus 100 according to the present example embodiment. The present example embodiment is similar to one of the other example embodiments described above except that the present example embodiment includes a configuration that determines a display form of a prime place region 410 of a screen 400 by use of a position of a customer inside a store S. A configuration according to the present example embodiment may be combined with at least one of configurations according to other example embodiments within a scope that does not cause a contradiction.

The information processing apparatus 100 further includes a decision unit 106 that decides a display form of the prime place region 410 of the screen 400 by use of a position of a customer (user U) inside the store S.

A display processing unit 102 displays the prime place region 410 of the screen 400 in a decided display form.

Various determination methods of a position of a user inside the store S can be conceived, and are exemplified below, but the present invention is not limited thereto. Moreover, a plurality of the following may be combined.
(1) GPS position information of a user terminal 300 of the user U is acquired and determined.
(2) After store entry of the user U is detected by use of a camera 50 in the store S, a position is determined by tracking a movement of the user U in the store S by image processing.
(3) A two-dimensional code such as a QR code storing identification information is posted or displayed at a predetermined position inside the store S, the QR code is read from an operation image of a camera 304 of the user terminal 300, and a position is determined.
(4) When the user terminal 300 receives a beacon transmitted from a Bluetooth communication apparatus provided at a predetermined position inside the store S, identification information included in the beacon is acquired, the communication apparatus is determined, and a position of the user U is determined from the position of the apparatus. Alternatively, identification information of the user terminal 300 that has responded to the beacon of the Bluetooth communication apparatus is acquired, and a position of the user terminal 300 is determined.
(5) Similar to the example embodiment described above, a position of a display shelf 20 is determined from an image captured with the camera 304 of the user terminal 300, and designated as a position of the user U.

A display form is, for example, a type of a product to be displayed or an arrangement way thereof.

For example, when it can be determined that the user U is present near the display shelf 20 of a roux of curry or the like, the display processing unit 102 displays, in the prime place region 410, a content of a specific product 32 predetermined as a sales promotion target among roux of curry, at a position (e.g., 1-1, 1-2, or the like in FIG. 7(a)) being high in display order.

Further, in the present example embodiment, in a case where a position of the user U is determined, the user may be guided, when the user U presses a content display portion 430 displayed in the screen 400 in the above example embodiment, to a route to a display location of a product displayed on the pressed content display portion 430. For example, a current position of a user and a display location of a product may be marked on a layout diagram of the store S, and a route may be drawn.

According to the present example embodiment, since an advantageous effect similar to that according to the first example embodiment is provided, and, further, a product to be displayed can be changed according to a position of a customer, an opportunity for product purchase can be given to a customer, for example, by displaying a product on the display shelf 20 near the customer in the prime place region 410, and this can effectively lead to sales promotion.

### Fifth Example Embodiment

The present example embodiment is the same as at least one of the other example embodiments described above except that the present example embodiment includes a configuration that changes a product to be displayed on a prime place region 410 of a screen 400 to information of a product displayed on a golden line of a display shelf 20 in a real store S, in response to selection of a product displayed in a secondary place region 420. The present example embodiment is described by use of FIG. 3 according to the first example embodiment. However, a configuration according to the present example embodiment may be combined with at least one of configurations according to other example embodiments within a scope that does not cause a contradiction.

When accepting selection of a product displayed in the secondary place region 420 of the screen 400, a display processing unit 102 displays, in the prime place region 410 of the screen 400, a product at a predetermined height in the display shelf 20 on which the selected product is displayed.

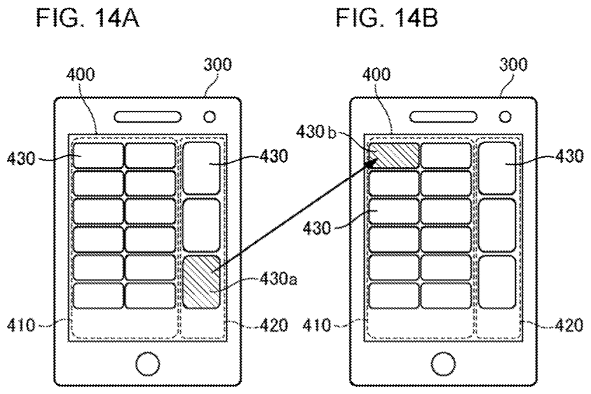

FIG. 14 is a diagram for describing transition of the screen 400. In an example of the screen 400 in FIG. 14, the prime place region 410 and the secondary place region 420 are disposed side by side in a left-right direction, unlike an example of the screen 400 in FIG. 6 according to the example embodiment described above. The prime place region 410 is disposed on a left side of the screen 400, and the secondary place region 420 is disposed on a right side. However, in the present example embodiment as well, the prime place region 410 and the secondary place region 420 may be disposed side by side in an up-down direction as in FIG. 6.

Moreover, in the example in FIG. 14, the prime place region 410 of the screen 400 is larger in area than the secondary place region 420. Further, the number of products (the number of content display portions 430) displayed in the prime place region 410 is more than that in the secondary place region 420. However, the display form of the screen 400 according to the present example embodiment is not limited thereto.

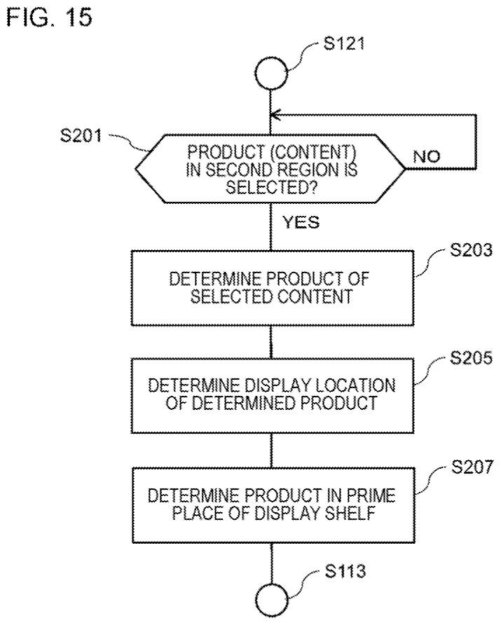

FIG. 15 is a flowchart illustrating an operation example when the content display portion 430 in the secondary place region 420 of the screen 400 is pressed. For example, when accepting pressing (selection) of a content display portion 430a in the secondary place region 420 of the screen 400 in FIG. 14(a) (YES in step S201), the display processing unit 102 acquires, from display information 130 in FIG. 7(b), a content ID displayed on the display portion 430 that has accepted the pressing (selection). Then, the display processing unit 102 determines, with reference to content information 122 in FIG. 7(a), a product (product code) being associated to the acquired content ID (step S203).

Further, the display processing unit 102 determines a location where a product with the determined product code is displayed (step S205). Various determination methods of a display location of a product can be conceived, and are exemplified below, but the present invention is not limited thereto. Moreover, a plurality of the following may be combined.
(1) Information of a product displayed on each of the display shelves 20 is registered in a storage apparatus 120 in advance as display information by associating a product code with a display location, and determines the display shelf 20 being associated to the product code with reference to the display information.
(2) A face image of a product or a feature value thereof is stored in the storage apparatus 120 as product information in association with a product code. From an image of each of the display shelves 20 captured by a camera 50 in the store S, a product that matches a face image of a product of the determined product code by equal to or more than a threshold value is detected by image processing. The display shelf 20 targeted for capturing an image, in which a product image has been detected, is determined.
(3) Identification information (e.g., a two-dimensional code) indicating a location is posted (or displayed on a display) on a shelf of the display shelf 20, and also a price tag of a product (or the two-dimensional code storing product information) and the two-dimensional code of the shelf are captured by the camera 50 in the store S. A display location is determined, by image processing, from the two-dimensional code of the shelf of the display shelf 20 in which the two-dimensional code indicating the determined product code has been detected.

Then, the display processing unit 102 determines a product in a prime place 22 of the determined display shelf 20 (step S207). Various determination methods of a product in the prime place 22 of the display shelf 20 can be conceived, and are exemplified below, but the present invention is not limited thereto. Moreover, a plurality of the following may be combined.
(1) Information (product code) of a product displayed in the prime place 22 of each of the display shelves 20 is registered in the storage apparatus 120 in advance, and the display shelf 20 being associated to the product code is determined with reference to display information.
(2) An image captured with the camera 50 in the store S is subjected to image recognition processing, and a product displayed in the prime place 22 of the determined display shelf 20 is determined.

When a product is determined, the processing proceeds to step S113 in FIG. 10, and a content of the determined product is displayed at a position of the content display portion 430 being high in display order in the prime place region 410 of the screen 400, for example, a content display portion 430b in FIG. 14.

Along with a change of a product (content) to be displayed in the content display portion 430 in the prime place region 410, a product (content) to be displayed on the secondary place region 420 may be further changed (steps in and after S117 in FIG. 10 are executed), or may not be changed. The screen 400 may include an update button (not illustrated). When it is sensed that pressing of the update button is accepted after a product (content) to be displayed in the prime place region 410 is changed, processing (processing in and after step S119 in FIG. 10) of changing a product (content) to be displayed in the secondary place region 420 may be executed.

According to the present example embodiment, when a product displayed in the secondary place region 420 is selected by a user U, information of a product displayed in the prime place 22 of the display shelf 20 where the product is actually displayed can be displayed in the prime place region 410, and, therefore, a product that the store S, a manufacturer, or the like desires to sell can be efficiently recommended to a customer.

Although the example embodiments according to the present invention have been described above with reference to the drawings, the example embodiments are exemplifications of the present invention, and various configurations other than the above can be also adopted.

### <Utilization of RF Tag>

For example, a method of processing an image has been described as a method of acquiring information of a product displayed on the display shelf 20. In another example, a product or the display shelf 20 may be provided with a radio frequency (RF) tag, information stored in the RF tag may be acquired, and, thereby, information of the product displayed on the display shelf 20 may be acquired.

For example, product information may be acquired in the store S by use of a reader for reading an RF tag, and product information may be stored in the storage apparatus 120 as display information in association with a position of the display shelf 20.

### <Provision of Inventory Information of Product>

Further, the display processing unit 102 may display inventory information of a product on a user terminal 300 as information relating to the product. A region that displays inventory information of a product may be the prime place region 410 of the screen 400, or may be the secondary place region 420.

Inventory information of a product may be (1) limited to the number of products arranged in a store (the display shelf 20), or may be (2) the number of products including a product stored in a backyard of the store S.

In a case of (1) described above, the number of products can be computed by, for example, a weight sensor 60 provided on the display shelf 20. For example, weight of a product displayed on the display shelf 20 can be measured, and the number of products can be computed from weight of one of the products. Alternatively, the number of products may be estimated by processing an image of the display shelf 20.

In a case of (2) described above, for example, inventory information managed by a point of sales (POS) terminal (not illustrated) in the store S may be acquired.

### <Display of Third Region>

The screen 400 may further include a third region separate from a first region (prime place region 410) and a second region (secondary place region 420). What is displayed in the third region includes at least one of a past history of the user U (a recently bought product, a product bought in the same period one year ago, a product with high purchase frequency (a repeatedly purchased product), or the like), current cart status, an operation unit of a function of calling a clerk, a selection unit of a linking function with a smartphone shopping application (icons of various applications), storage status of a product stored in a refrigerator, a storage, a pantry, or the like at a home of the user U, and the like, or a combination thereof.

Information displayed in the third region may be a product being related to a product caused to be a product in the first region or the second region, or may be an unrelated product. For example, as an example of a related product, information of food stored in a refrigerator at a home of the user U may be displayed in the third region, when, in a place where a roux of curry is sold, a product of a roux of curry is displayed in the first region, and information of a potato or the like being an ingredient of curry is displayed in the second region. Alternatively, in a case of a function of calling a clerk, a clerk being in charge of a related product may be able to be called. As an example of an unrelated product, for example, an icon of a smartphone shopping application that sells a product targeted for sales promotion by a manufacturer or the like may be displayed in the third region.

### <Sales Promotion Based on Customer Information>

The specific product 32 is configured to be specified by the store S or a trader in the example embodiment described above, but may be determined based on customer information in another example.

For example, a product to be displayed on the screen 400 may be determined or narrowed according to information such as a purchase history, a preference, or an allergy of the user U. For example, the user U is caused to register, at user registration or the like, customer information relating to a preference or an allergy of each of the users U, and the customer information is stored in the storage apparatus 120 as user information. Alternatively, a purchase history of the user U in the store S is stored in the storage apparatus 120.

The information processing apparatus 100 further includes a customer identification unit (not illustrated) that identifies a customer. The customer identification unit identifies the user U, based on a user ID acquired at login from the user terminal 300, for example, when the user U enters the store S. The display processing unit 102 may narrow down a product to be displayed, based on a purchase history of the identified user U, customer information of the user U, or the like, and display, on the screen 400, information relating to the narrowed product.

Various methods of narrowing down a product can be conceived, and are exemplified below, but the present invention is not limited thereto. Moreover, a plurality of the following may be combined.
(1) A product with high purchase frequency is determined from a purchase history, and the determined product or another product being similar to the product is selected. A similar product is, for example, a product of the same brand or manufacturer, a product in the same price range, or the like. Moreover, among other similar products, a product having a slightly higher price or higher quality than the determined product may be selected.

For example, for a user who often purchases a Chilean wine, a Chilean wine may be selected, or a French wine being more expensive than a Chilean wine may be selected, for example, on a condition of a specific period such as year-end and New Year holidays.
(2) A product is registered according to classification of a preference, and a product classified into a preference registered by the user U is selected. For example, when a user has registered preference for Japanese food, an ingredient (e.g., fish or the like) to be a material for Japanese food may be selected.
(3) For each ingredient to be an allergy target, a product including the ingredient is registered, and a product including an ingredient of the allergy target specified by the user U is excluded from a product to be displayed. For example, in a case of a user for whom a wheat allergy is registered, a product containing wheat is excluded. Alternatively, a product purchase of which is desired to be avoided for a religious reason may be able to be registered.

A region to which the narrowing down a product to be displayed is applied may be the prime place region 410 of the screen 400, or may be the secondary place region 420.

<Cooperation with External Server>

For example, a product to be displayed in the secondary place region 420 of the screen 400 may be changeable by an external server, for example, a server of a manufacturer, a dealer, or the like. The external server may be connectable to the information processing apparatus 100 via a communication network 2. A screen in which information relating to a product to be displayed in the secondary place region 420 is input can be displayed in the external server, and the display processing unit 102 can acquire the input product information.

<Relationship between the Prime Place 22 in the Real Store S and the Prime Place Region 410 of the Screen 400>

The content display portion 430 inside the prime place region 410 that displays information being related to a product displayed in the prime place 22 of the display shelf 20 in the real store S may be disposed in the same way as actual display status of the display shelf 20, or may be disposed differently.

While the invention of the present application has been described above with reference to the example embodiments and examples, the invention of the present application is not limited to the example embodiments and examples described above. Various modifications understandable to a person skilled in the art can be made to a configuration and details of the invention of the present application within the scope of the invention of the present application.

Note that, when information relating to a user is acquired and utilized in the present invention, the acquisition and utilization are to be performed legally.

Some or all of the above-described example embodiments can also be described as, but are not limited to, the following supplementary notes.

1. An information processing apparatus including
a display processing unit that transmits information relating to a product to a terminal of a customer being present in a store, and causes the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

2. The information processing apparatus according to supplementary note 1, wherein,
when a product that should be displayed in the second region of the screen overlaps a product that should be displayed in the first region of the screen, the display processing unit does not display the overlapping product in the second region.

3. The information processing apparatus according to supplementary note 2, wherein
the display processing unit further highlights the overlapping product in the first region of the screen.

4. The information processing apparatus according to any one of supplementary notes 1 to 3, wherein
the first region of the screen is larger in area than the second region, and
a number of products displayed in the first region is more than that in the second region.

5. The information processing apparatus according to any one of supplementary notes 1 to 4, wherein
the specific location is a shelf at a predetermined height, or a corner lot in a display shelf region.

6. The information processing apparatus according to supplementary note 5, further including
a product determination unit that determines the product displayed at the specific location, by processing an image capturing the shelf inside the store, wherein
the display processing unit
   displays the determined product in the first region of the screen.

7. The information processing apparatus according to any one of supplementary notes 1 to 6, wherein
a product displayed in the second region is changeable by an external server.

8. The information processing apparatus according to any one of supplementary notes 1 to 7, further including
a decision unit that decides a display form of the first region of the screen by use of a position of the customer inside the store, wherein
the display processing unit displays the first region in the determined display form.

9. The information processing apparatus according to any one of supplementary notes 1 to 8, wherein,
when accepting selection of the product displayed in the second region of the screen, the display processing unit displays, in the first region of the screen, a product at a predetermined height in a display shelf on which the selected product is displayed.

10. The information processing apparatus according to any one of supplementary notes 1 to 9, wherein
the display processing unit
   further displays inventory information of the product as information relating to the product.

11. The information processing apparatus according to any one of supplementary notes 1 to 10, further including
a customer identification unit that identifies the customer, wherein
the display processing unit
   narrows down a product to be displayed, by use of customer information of the identified customer, and
   displays, on the terminal of the customer, information relating to the narrowed product.

12. An information processing method including,
by an information processing apparatus,
transmitting information relating to a product to a terminal of a customer being present in a store, and causing the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

13. The information processing method according to supplementary note 12, further including,
by the information processing apparatus,
when a product that should be displayed in the second region of the screen overlaps a product that should be displayed in the first region of the screen, not displaying the overlapping product in the second region.

14. The information processing method according to supplementary note 13, further including,
by the information processing apparatus,
further highlighting the overlapping product in the first region of the screen.

15. The information processing method according to any one of supplementary notes 12 to 14, wherein
the first region of the screen is larger in area than the second region, and
a number of products displayed in the first region is more than that in the second region.

16. The information processing method according to any one of supplementary notes 12 to 15, wherein
the specific location is a shelf at a predetermined height, or a corner lot in a display shelf region.

17. The information processing method according to supplementary note 16, further including,
by the information processing apparatus:
processing an image capturing the shelf inside the store, and thereby determining the product displayed at the specific location; and
displaying the determined product in the first region of the screen.

18. The information processing method according to any one of supplementary notes 12 to 17, wherein
a product displayed in the second region is changeable by an external server.

19. The information processing method according to any one of supplementary notes 12 to 18, further including,
by the information processing apparatus:
deciding a display form of the first region of the screen by use of a position of the customer inside the store; and
displaying the first region in the determined display form.

20. The information processing method according to any one of supplementary notes 12 to 19, further including,
by the information processing apparatus,
when accepting selection of the product displayed in the second region of the screen, displaying, in the first region of the screen, a product at a predetermined height in a display shelf on which the selected product is displayed.

21. The information processing method according to any one of supplementary notes 12 to 20, further including,
by the information processing apparatus,
further displaying inventory information of the product as information relating to the product.

22. The information processing method according to any one of supplementary notes 12 to 21, further including,
by the information processing apparatus:
identifying the customer;
narrowing sown a product to be displayed, by use of customer information of the identified customer, and
displaying, on the terminal of the customer, information relating to the narrowed product.

23. A program for causing a computer to execute
a procedure of transmitting information relating to a product to a terminal of a customer being present in a store, and causing the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

24. The program according to supplementary note 23, for causing the computer to execute
a procedure of, when a product that should be displayed in the second region of the screen overlaps a product that should be displayed in the first region of the screen, not displaying the overlapping product in the second region.

25. The program according to supplementary note 24, for causing the computer to execute a procedure of further highlighting the overlapping product in the first region of the screen.

26. The program according to any one of supplementary notes 23 to 25, wherein
the first region of the screen is larger in area than the second region, and
a number of products displayed in the first region is more than that in the second region.

27. The program according to any one of supplementary notes 23 to 26, wherein
the specific location is a shelf at a predetermined height, or a corner lot in a display shelf region.

28. The program according to supplementary note 27, for causing the computer to execute:
a procedure of determining the product displayed at the specific location, by processing an image capturing the shelf inside the store; and
a procedure of displaying the determined product in the first region of the screen.

29. The program according to any one of supplementary notes 23 to 28, wherein
a product displayed in the second region is changeable by an external server.

30. The program according to any one of supplementary notes 23 to 29, for causing the computer to execute:
a procedure of deciding a display form of the first region of the screen by use of a position of the customer inside the store; and
a procedure of displaying the first region in the determined display form.

31. The program according to any one of supplementary notes 23 to 30, for causing the computer to execute
a procedure of, when accepting selection of the product displayed in the second region of the screen, displaying, in the first region of the screen, a product at a predetermined height in a display shelf on which the selected product is displayed.

32. The program according to any one of supplementary notes 23 to 31, for causing the computer to execute
a procedure of further displaying inventory information of the product as information relating to the product.

33. The program according to any one of supplementary notes 23 to 32, for causing the computer to execute:
a procedure of identifying the customer;
a procedure of narrowing down a product to be displayed, by use of customer information of the identified customer; and
a procedure of displaying, on the terminal of the customer, information relating to the narrowed product.

This application is based upon and claims the benefit of priority from Japanese patent application No. 2020-207781, filed on Dec. 15, 2020, the disclosure of which is incorporated herein in its entirety by reference.

### REFERENCE SIGNS LIST

1 Sales promotion system
2 Communication network
20 Display shelf
22 Prime place
24 End display portion
30 Product
32 Specific product
100 Information processing apparatus (server)
102 Display processing unit
104 Product determination unit
106 Decision unit
120 Storage apparatus
122 Content information
124 Related information
130 Display information
200 Content server
220 Content storage apparatus
300 User terminal
302 Touch panel
304 Camera
40 Store apparatus
42 Storage apparatus
50 Camera
60 Sensor
70 Display apparatus
400 Screen
410 Prime place region
420 Secondary place region
430 Content display portion
1000 Computer
1010 Bus
1020 Processor
1030 Memory
1040 Storage device
1050 Input/output interface
1060 Network interface

What is claimed is:

1. An information processing apparatus comprising:
at least one memory configured to store instructions; and
at least one processor configured to execute the instructions to:
transmit information relating to a product to a terminal of a customer being present in a store, and cause the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

2. The information processing apparatus according to claim 1, wherein,
the at least one processor is further configured to execute the instructions
when a product that should be displayed in the second region of the screen overlaps a product that should be displayed in the first region of the screen, not to display the overlapping product in the second region.

3. The information processing apparatus according to claim 2, wherein
the at least one processor is further configured to execute the instructions to
further highlight further highlight the overlapping product in the first region of the screen.

4. The information processing apparatus according to claim 1, wherein
the first region of the screen is larger in area than the second region, and
a number of products displayed in the first region is more than that in the second region.

5. The information processing apparatus according to claim 1, wherein
the specific location is a shelf at a predetermined height, or a corner lot in a display shelf region.

6. The information processing apparatus according to claim 5, further comprising
the at least one processor is further configured to execute the instructions to:
determine the product displayed at the specific location by processing an image capturing the shelf inside the store; and
display the determined product in the first region of the screen.

7. The information processing apparatus according to claim 1, wherein
a product displayed in the second region is changeable by an external server.

8. The information processing apparatus according to claim 1, wherein
the at least one processor is further configured to execute the instructions to:
decide a display form of the first region of the screen by use of a position of the customer inside the store; and
display the first region in the determined display form.

9. The information processing apparatus according to claim 1, wherein,
the at least one processor is further configured to execute the instructions to:
when accepting selection of the product displayed in the second region of the screen, display, in the first region of the screen, a product at a predetermined height in a display shelf on which the selected product is displayed.

10. The information processing apparatus according to claim 1, wherein
the at least one processor is further configured to execute the instructions to:
further display inventory information of the product as information relating to the product.

11. The information processing apparatus according to claim 1, wherein
the at least one processor is further configured to execute the instructions to:
identify the customer;
narrow down a product to be displayed, by use of customer information of the identified customer; and
display, on the terminal of the customer, information relating to the narrowed product.

12. An information processing method comprising,
by an information processing apparatus,
transmitting information relating to a product to a terminal of a customer being present in a store, and causing the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.

13. A non-transitory computer-readable storage medium storing a program for causing a computer to execute
a procedure of transmitting information relating to a product to a terminal of a customer being present in a store, and causing the terminal to display the information on a screen, wherein
the screen includes a first region, and a second region demarcated from the first region,
a product displayed in the first region of the screen is a specific product displayed in a specific location inside the store, and
a product displayed in the second region of the screen is either a product being related to a type of the specific product displayed in the first region, or a product specified by the store or a trader.
